(19) United States
(12) Patent Application Publication
(10) Pub. No.: US 2010/0205599 A1
(43) Pub. Date: Aug. 12, 2010

(54) MECHANISM TO ENABLE PLUG-AND-PLAY HARDWARE COMPONENTS FOR SEMI-AUTOMATIC SOFTWARE MIGRATION

(75) Inventors: Vinay Vaidya, Pune (IN); Jaydeep Vipradas, Pune (IN)

Correspondence Address: MAIER & MAIER, PLLC, 1000 DUKE STREET, ALEXANDRIA, VA, 22314, US

(73) Assignee: KPIT CUMMINS INFOSYSTEMS LTD., Pune (IN)

(21) Appl. No.: 12/678,850

(22) PCT Filed: Sep. 19, 2008
(86) PCT No.: PCT/IB08/53816

§ 371 Date: Mar. 18, 2010

(30) Foreign Application Priority Data
Sep. 19, 2007 (IN) 1814/MUM/2007

(51) Int. Cl. G06F 9/445

(52) U.S. Cl. 717/174

(57) ABSTRACT

A method and device for dealing with problem of software-incompatibility or obsolescence of hardware. The method includes copying of information regarding architecture and other features from hardware components, conversion of existing hardware-specific software to suit architecture of new hardware component and transmittal of adapted software to new hardware. The method and device provide for enabling semi automatic migration of hardware-specific software between hardware components such as computer processors. This process of software migration, in turn, provides for effective transfer of functionality from one hardware component to the other. This novel process can be used for migration of software from one processor to the other.

### FIELD OF THE INVENTION

This invention is related to computer and other electronic systems and particularly to processors and other hardware devices. More particularly, the present invention relates to mechanisms and systems to overcome the processor and hardware obsolescence problem encountered in their use in computers and other electronic systems. In addition, this invention finds applicability in software migration from one microprocessor to the other.

### BACKGROUND OF THE INVENTION

Processors or microprocessors and other hardware devices that form part of computer or other electronic systems are constantly evolving with newer and higher configurations or capabilities replacing the older ones. There has been a general trend in the computer hardware industry to develop newer generations of faster microprocessors. Also, production of older hardware ceases in purview of shift in market needs towards new generation hardware. Few of these new product generations are backward compatible and hence, functionality problems with existing Instruction Set Architecture (ISA) and other hardware features are common. This leads to compatibility problems between the older and newer components and therefore, a hindrance in the plug-and-play adaptation of processor and other hardware devices. Also when one has to intentionally migrate to a new microprocessor, the entire software code of has to be rewritten or modified to suit the new processor.

Methods and systems to overcome the problem have been cited in the prior art.

One of the methods used to overcome this problem is the porting or rewriting of complete software or pieces of software to follow new methodologies. It may also involve configuring other hardware and/or software components to suit the new processor or hardware component. However, as this method involves spending time and money over old software and/or hardware, most companies are reluctant towards its implementation in context of their aggressive market-driven resource optimization policies.

Another method that has been used to overcome this problem is the emulation of the obsolete processor by means of Field Programmable Gate Array (FPGA). However, this approach is expensive and hence finds little application in the industry.

The patent document number US2006/0282254A1 describes a system and method for component obsolescence in microprocessor based control units. The method comprises of providing a second vehicle system control unit for performing substantially the same operation as that of the first vehicle system control unit, wherein the second vehicle system control unit having a programmable hardware device adapted to emulate the operation of the core functional portion of the microprocessor. However, this process is manual and thus obleviates ease of ‘plug and play’ type of changes in hardware.

Another method to address the said problem is to implement hardware abstraction layer in the software design to minimize the efforts to port the software for the new hardware component. The patent document number WO01/061490A3 describes a method of implementing hardware abstraction layer for abstraction of processor specific functionality to the operating system. In particular, it abstracts configurable processor features visible to the operating system to provide a uniform, standardized interface between the operating system and the configurable processor on which it runs. This method provides for functionality of the operating system on all configurations of the processor which, in turn, are covered by the hardware abstraction layer. This method, however, suffers from a drawback that it is applicable in case of configurable processors and its implementation requires technical expertise. Apart from high cost, this method involves additional steps of software reengineering and reimplementation, which decrease overall ease of operation.

The methods and systems of the prior art have not been able to satisfactorily address the said problem.

The current inventors have come up with mechanisms and systems to overcome the said problem of hardware obsolescence and software incompatibility of devices/hardware components such as microprocessors.

The present invention provides for mechanisms and systems for addressing the problem of obsolescence of processors and other hardware and thus a mechanism to enable the plug-and-play of processors or other hardware components differing in configuration. The present invention also provides for devices and process for the conversion of existing software suited to one processor or hardware device to another processor or hardware device.

The invention provides the advantage of long-term, automated end-to-end solution for plug-and-play of processors and other hardware devices/components.

### SUMMARY OF THE INVENTION

The present invention relates to methods and devices for enabling migration of software between hardware components. The present invention provides for means to automate this software migration process.

In one form of the invention, the method of software migration commences with connecting hardware such as processors to a conversion device, either a computer system or an embedded device, which contains a migration tool. The conversion device then provides for porting of hardware-specific software advertised by one hardware component or processor to another hardware component or processor. This results in automatic transfer of functionality of the donor hardware component or processor to the recipient hardware component or processor.

To assist in understanding of the current invention, reference is hereby made to the accompanying drawing, which show one embodiment of the invention

### OBJECT OF THE INVENTION

It is an object of this invention to provide for methods to enable migration of software between different hardware components such as processors. Another object of this invention is to provide for devices for enabling semi automatic migration of software to new hardware component or processor, and thus, mechanisms to enable ‘plug and play’ different hardware components.

### BRIEF DESCRIPTION OF THE DRAWINGS

FIG. 1 illustrates one way in which current invention can be performed. (7) represents an conversion device. New processor (1) initiates advertisement of own architecture and features to conversion system (3). The conversion system (3) may be a separate device or an embedded device within the same system. Conversion system (3) converts software components to suit new processor (1). (2) represents old processor, (4) represents the memory of the system (7), (6) represents the old application and (5) represents the new or modified application.

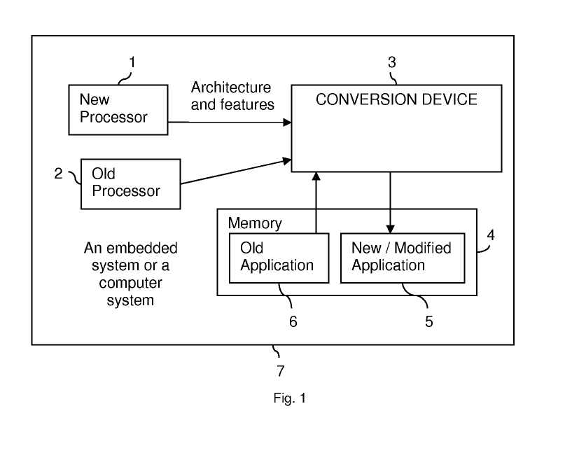

### DETAILED DESCRIPTION OF THE INVENTION

The present invention provides for mechanisms and systems to address the problems of software-incompatibility and obsolescence of hardware. The invention would provide for the enablement of plug-and-play of hardware components such as processors differing in hardware and/or software configuration and capabilities.

According to the present invention, the system or mechanisms comprises of a process where the processor or other hardware device/components advertise or exchange information regarding their architecture and other features to other software, processor or hardware device/components. The exchange process may be either initiated by the first processor or hardware device/components or the second processor or hardware device/components. How to advertise architecture and features and what to advertise as features of processor or other hardware component is flexible. It employs that the formatting, encoding and method of exchanging information is flexible.

The architecture advertised by the processor or hardware device/component may be but not limited to the number of registers, names of registers, size of each register, size of address bus/data bus, pin configuration of the processor, range of memory it can handle, types of memory models supported by the processor, number of interrupts and their types supported by the processor. The advertisement of the architecture may be complete or partial. The processor or hardware device/component may also advertise some or all of its software as its feature.

The invention additionally comprises of a device that can be plugged into a computer or embedded system and which then converts the software components of the processor or hardware device/components to suit the other processor or hardware device/component. This conversion device could be a computer or an embedded device.

The plug-in referred to in this specification can be achieved by but not limited to wiring, soldering, socketing or wireless means.

In one embodiment of the invention, the user has to scan the source code of the hardware component and mark the hardware-specific source code. The user also needs to specify the context of the marked source code. Marking and specification of context of software code can be done by choosing among a multitude of ways, one of which is the use of tags.

The invention additionally comprises of a new method for the conversion of existing software that is suited to one processor or hardware device/component to suit a different processor or hardware component/device.

The effective migration of software from one hardware to another is achieved by using marked software provided to the conversion device. The method mentioned for the conversion of the hardware-specific software is effected through a migration tool comprising a converter software running on the conversion device which receives the input from one processor or hardware device/component and then modifies the software applications that already exist on the system to be able to execute on the new processor. The said converter software may be running on a separate integrated circuit, computer or embedded system.

The said converter software may modify the existing source code and/or generate some new code to exploit new processor features by an application that would run on it by using processor information and features advertised by them. The migration tool thus contains an executable software code that serves to port hardware-specific software from old hardware to new hardware.

In the preferred embodiment of the invention, the software migration process involves a one-time manual activity of scanning the source code of both old and new processors and marking the processor specific source codes. This tagged information may be manually supplied to the conversion device as processor information files created using processor manuals. C or any other language syntax handling tool may be used to identify markings and point out classes of issues including ports and registers in the source code. The actual migration process, in the preferred embodiment of the invention, comprises of distinct stages of definition of source code for each class of issues, selection of target code of new processor that confirms with the selected class and issue and finally, updating the target code to suit the new hardware. For each class of every issue, there is a defined set of rules which may be used for updating of the target code to suit new processor. Updating of the target code comprises inter alia, copying of issue and class-specific code from old hardware to new hardware.

The processor can communicate with memory and the conversion system and also the conversion system can communicate with processor and memory.

In this embodiment, the process of software migration involves a stage of manually creating files or database of marked hardware-specific software and specifying the context. Thus, the process of software migration was semi automatic. However, this manual input is required only once and all subsequent events of porting of the converted software are fully automatic.

The same technique can be applicable for plug-and-play of any hardware devices used as peripherals as well. For example, plug-and-play of new LCD device would need that the new device should be able to advertise its features such as resolution, dimensions, pin configurations, etc to software component that would use it.

The following example further illustrates the invention. This example is for illustration purpose only and does not limit the scope of the invention.

### Example 1

Migration of processor-specific source code from Freescale MC68332 microprocessor to MC68340 microprocessor: The two processors were connected to a desktop computer conversion system containing the migration tool, which provided for copying of processor information advertised by the former processor into its own memory and then transferring it to the latter processor on receipt of request or interrupt to that effect. Source code conversion process was carried out on desktop.

1. A method for enabling migration of hardware-specific software from one hardware component to another comprising:
connecting old and new hardware components to a conversion device containing a migration tool;
advertising of own architecture and features by hardware components to other hardware and software components and the conversion device;
marking and specifying context for hardware-specific software;
copying of tagged hardware-specific software to a memory device;
converting of existing hardware-specific software to suit architecture and features of new hardware; and
transmitting of converted software to new hardware.

2. The method according to claim 1, wherein the hardware further comprises a microprocessor.

3. The method according to claim 1, wherein the migration tool further comprises of software code for porting of hardware-specific software from one hardware component to other hardware component, the software code further comprising:
defining source code by identification of software for a particular hardware in the file containing hardware-specific software of the old hardware;
selecting target code by identification of software for defined hardware in the file containing hardware-specific software of the new hardware; and
updating of target code to match functionality of defined hardware.

4. The migration tool according to claim 3, wherein process of updating target code further comprises replication, either in part or full, of hardware-specific software from old hardware to new hardware.

5. The method according to claim 1, wherein connection between hardware components is established using at least one of wiring, soldering, socketing or wireless connectivity.

6. The method according to claim 1, wherein advertisement of architecture and features is partial.

7. The method according to claim 1, wherein marking and specifying the context of hardware-specific software further comprises incorporation of tags.

8. The method according to claim 1, wherein conversion refers to adaptation of hardware-specific software applications running on the system to be able to execute on the new processor.

9. The method according to claim 1, wherein the memory device comprises of system memory of the conversion device which is a computer.

10. A device for enabling conversion of hardware-specific software from one hardware component to another comprising:
a memory device;
a migration took;
a power source;
a processor; and
an input-output interface.

11. The method according to claim 1, wherein advertisement of architecture and features is complete.

12. The method according to claim 1, wherein the memory device comprises of system memory of the conversion device which is an embedded system.
